(19) United States
(12) Patent Application Publication
(10) Pub. No.: US 2024/0268414 A1
(43) Pub. Date: Aug. 15, 2024

(54) TEXTURIZED-PROTEIN FOOD INGREDIENT

(71) Applicant: J-OIL MILLS, INC., Chuo-ku, Tokyo (JP)

(72) Inventors: Kai YAMAGATA, Tokyo (JP); Junpei KUBOTA, Tokyo (JP); Tomoki HORIGANE, Tokyo (JP); Saika SATO, Tokyo (JP); Naoko DODO, Tokyo (JP); Kentaro TANI, Tokyo (JP); Ryuji HORI, Tokyo (JP); Takashi SANO, Tokyo (JP)

(73) Assignee: J-OIL MILLS, INC., Chuo-ku, Tokyo (JP)

(21) Appl. No.: 18/568,267

(22) PCT Filed: Jun. 14, 2022
(86) PCT No.: PCT/JP2022/023835

§ 371 Date: Dec. 7, 2023

(30) Foreign Application Priority Data
Jun. 14, 2021 (JP) 2021-098974

(51) Int. Cl. A23J 3/20; A23J 3/16; A23J 3/22; A23J 3/26; A23J 3/28

(52) U.S. Cl. CPC A23J 3/20; A23J 3/16; A23J 3/227; A23J 3/26; A23J 3/28

(57) ABSTRACT

The present invention relates to a texturized-protein food ingredient in which an algae-derived protein raw material is used, the food ingredient having exceptional color, aroma, and mouthfeel. This texturized-protein food ingredient is characterized by containing a texturized protein obtained by texturizing a raw material mixture including (a) an algae-derived protein raw material and (b) a protein raw material that is different from (a) and that has a protein content of 70 mass % or greater. Combining (a) the algae-derived protein raw material and (b) the protein raw material that is different from (a) and that has a protein content of 70 mass % or greater, as protein raw materials, makes it possible to obtain a texturized protein having exceptional expansion properties.

### TECHNICAL FIELD

The present invention relates to a texturized-protein food ingredient, a food product containing the texturized-protein food ingredient, and a method for improving the texture of a food product using the texturized-protein food ingredient.

### BACKGROUND ART

In recent years, algae have attracted attention as a nutritional ingredient, and a variety of food products containing algae have been developed.

However, if algae is directly added to a food product, the color of the food product becomes greenish and the food product will have unpleasant appearance. In addition, the original flavor of the food product will be spoiled by the smell of the sea peculiar to the algae. Furthermore, if algae is added directly to a food product, the original texture of the food product may change. Therefore, when algae is added to a food product by itself, it may affect the original tastiness of the food product in terms of color, smell, and texture, and thus has a problem as a food ingredient.

As an exemplary food ingredient containing algae, Non-patent literature 1 describes that a fibrous texturized protein obtained by extruding a mixture of chlorella and a concentrated soybean protein is useful as a meat-like food ingredient.

In addition, Patent literature 1 and 2 describe that a texturized product obtained by extruding a mixture containing soybean and algae is useful as a functional soybean food product. Furthermore, Patent literature 3 describes that a texturized product obtained by extruding a mixture of chlorella, starch, and defatted soybean flour is useful as a functional food product.

However, conventionally known texturized-protein food ingredients easily develop algae-derived flavors and colors, and weaken the texture, and thus they sometimes spoil the original tastiness of the food product when added to said food product.

### CITATION LIST

### Patent Literature

Patent literature 1: Japanese Unexamined Patent Application Publication No. H4 (1992)-58853
Patent literature 2: Japanese Unexamined Patent Application Publication No. H4 (1992)-88958
Patent literature 3: Japanese Unexamined Patent Application Publication No. H2 (1990)-142447

### Non-Patent Literature

Non-patent literature 1: M. P. Caporgno, et al, Innovative Food Science and Emerging Technologies 59 (2020) 102275

### SUMMARY OF INVENTION

### Technical Problem

It is desirable to provide a texturized-protein food ingredient using an algae-derived protein raw material, which has reduced color and smell peculiar to the algae, has a moderate texture when it is rehydrated in water, and has superior color, smell, and texture.

### Solution to Problem

The present invention provides a texturized-protein food ingredient, a food product containing the same, a method for producing the texturized-protein food ingredient, and a method for improving the texture of a food product using the texturized-protein food ingredient, which are described below.
[1] A texturized-protein food ingredient, comprising a texturized protein obtained by texturizing a raw material mixture containing:
   (a) an algae-derived protein raw material; and
   (b) a protein raw material that is different from (a) and that has a protein content of 70 mass % or more.
[2] The texturized-protein food ingredient according to [1] above, wherein the algae is one or two species selected from the group consisting of euglena and defatted euglena.
[3] The texturized-protein food ingredient according to [1] or [2] above, wherein the protein content in the raw material mixture is 35 mass % or more based on the total amount of said raw material mixture.
[4] The texturized-protein food ingredient according to any one of [1] to [3] above, wherein (b) above comprises a soybean protein.
[5] The texturized-protein food ingredient according to [4] above, wherein the soybean protein comprises an isolated soybean protein.
[6] The texturized-protein food ingredient according to any one of [1] to [5] above, wherein the nitrogen solubility index (NSI) of (b) above is 55% or more but 100% or less.
[7] The texturized-protein food ingredient according to any one of [1] to [6] above, wherein the content of (a) above in the raw material mixture is 5 mass % or more but 90% or less based on the total amount of said raw material mixture.
[8] A food product comprising the texturized-protein food ingredient according to any one of [1] to [7] above.
[9] The food product according to [8] above, wherein the food product is selected from the group consisting of a processed meat food product, a processed meat-like food product, and a processed fishery product.
[10] A method for producing a texturized-protein food ingredient, comprising:
   Step (1) in which a raw material mixture containing:
   (a) an algae-derived protein raw material; and
   (b) a protein raw material that is different from (a) and that has a protein content of 70 mass % or more,
is pressurized and heat-treated in the presence of water to texturize the protein raw materials contained in said raw material mixture; and
   Step (2) in which the texturized product obtained in Step (1) above is dried to obtain a texturized protein.
[11] The method for producing a texturized-protein food ingredient according to [10] above, wherein the algae is one or two species selected from the group consisting of euglena and defatted euglena.
[12] The method for producing a texturized-protein food ingredient according to [10] or above, wherein the pressurizing and heat treatment include pressurizing and heat treatment with an extruder.
[13] A method for improving the texture of a food product, comprising blending the texturized-protein food ingredient according to any one of [1] to [7] above with the food product.

### Advantageous Effects of Invention

The present invention can provide a texturized-protein food ingredient using an algae-derived protein raw material, which has reduced color and smell peculiar to the algae, has a moderate texture when it is rehydrated in water, and has superior color, smell, and texture.

The texturized-protein food ingredient of the present invention can be used to impart the nutritional value of algae to a food product while minimizing the impact of the algae's unique color, smell, and texture on the tastiness of the food product.

### DESCRIPTION OF EMBODIMENTS

Hereinafter, each of the embodiments of the present invention will be described in more detail.

### 1. Texturized-Protein Food Ingredient

The texturized-protein food ingredient of the present invention is characterized by comprising a texturized protein obtained by texturing a raw material mixture containing:
(a) an algae-derived protein raw material; and
(b) a protein raw material that is different from (a) and that has a protein content of 70 mass % or more.

The texturized-protein food ingredient of the present invention is a food ingredient containing a texturized protein obtained by texturizing a raw material mixture containing (a) and (b) above, which can impart the nutritional value of the algae to a food product while minimizing the impact of the algae's unique color, smell, and texture on the tastiness of the food product.

In general, it is known that the quality of proteins can be converted by pressurizing and heat-treating a protein raw material in the presence of water so that the proteins can have a texturized structure. For example, when a protein raw material is pressurized and heat-treated in the presence of water using an extruder or the like, the protein is loosened, the protein chains are oriented in a certain direction, and the heat causes the protein chains to bind with each other, thereby giving the protein a texturized structure.

In the texturized-protein food ingredient of the present invention, a “texturized protein” refers to a dry product that is given a texturized structure by allowing the protein chains of protein raw materials (a) and (b) above and, if necessary, other protein raw materials, to bind to each other, and that is dried by removing excess moisture from the texturized protein raw materials. The moisture content in the texturized protein is preferably 10 mass % or less, more preferably 9 mass % or less, and still more preferably 8 mass % or less, based on the total amount of the texturized protein.

Hereinafter, (a) and (b) as well as other components used in the raw material mixture will be described.

### (a) Algae-Derived Protein Raw Material

Algae-derived protein raw materials used in the present invention are not particularly limited as long as they can be added to food products, and examples thereof include raw materials including proteins derived from algae such as spirulina, chlorella, euglena, kelp, nori seaweed, wakame seaweed, hijiki seaweed, mozuku seaweed, and Gelidiaceae.

These algae may be defatted. According to a preferred aspect of the present invention, the defatting treatment lightens the color and further reduces the smell peculiar to the algae.

Among these, one or two species selected from the group consisting of euglena and defatted euglena are particularly preferable in that they have high nutritional value and in that they are highly effective in reducing the color, smell, and texture peculiar to the algae that affect the tastiness of a food product when they are added as the texturized-protein food ingredients of the present invention to the food product.

An euglena used in the present invention is a microorganism classified in the genus Euglena, which is a group of eukaryotes belonging to the family Euglenaceae, order Euglenales, class Euglenoidea, phylum Euglenozoa (Excavata). The euglena used in the present invention may be the aforementioned microorganism, a variety thereof, a mutant thereof, or a related species of the family Euglenaceae.

Examples of species belonging to the genus Euglena include Euglena chadefaudii, Euglena deses, Euglena gracilis, Euglena granulata, Euglena mutabilis, Euglena proxima, Euglena spirogyra, and Euglena viridis. Among them, Euglena gracilis (E. gracilis) is particularly preferred.

The content of protein raw material (a) in the raw material mixture is preferably 5 mass % or more but 90 mass % or less, more preferably 10 mass % or more but 85 mass % or less, still more preferably 20 mass % or more but 80 mass % or less, yet still more preferably 30 mass % or more but 75 mass % or less, and particularly preferably 48 mass % or more but 70 mass % or less, based on the total amount of the raw material mixture.

Moreover, the content of protein raw material (a) may be, for example, 55 mass % or more, or 60 mass % or more, based on the total amount of the raw material mixture. According to the present invention, even if the content of protein raw material (a) is increased, its impact on the tastiness of a food product can be kept low, and the nutritional value of the algae can be efficiently imparted to the food product.

Furthermore, the content of protein raw material (a) is preferably 5 mass % or more but 90 mass % or less, more preferably 10 mass % or more but 85 mass % or less, still more preferably 20 mass % or more but 80 mass % or less, yet still more preferably 30 mass % or more but 78 mass % or less, and particularly preferably 50 mass % or more but 75 mass % or less, based on the total amount of the protein raw materials contained in the raw material mixture.

Moreover, the content of protein raw material (a) may be, for example, 55 mass % or more, or 60 mass % or more, based on the total amount of the protein raw materials contained in the raw material mixture.

When upper and lower limit values are indicated herein to define a numerical range, these upper and lower limit values can be combined as appropriate, and any numerical range obtained thereby is considered to be disclosed.

(b) Protein Raw Material that is Different from (a) and that has Protein Content of 70 Mass % or More

In the present invention, a protein raw material with a protein content of 70 mass % or more is used together with (a) above as a protein raw material. The use of the protein raw material with a protein content of 70 mass % or more facilitates a higher degree of texturization together with (a) above, further reduces the color and smell derived from the algae, and also facilitates the swelling of the texturized protein so that the texturized-protein food ingredient of the present invention can impart moderate firmness and elasticity when it is rehydrated in water. Therefore, when added to a food product, it can further reduce the impact on the original tastiness of the food product. In addition, it can improve the texture of the food product.

Here, “protein content” refers to crude protein content, which can be obtained by the combustion method (“Duma's method”, protein conversion factor 6.25).

In (b) above, the protein content is 70 mass % or more, preferably 75 mass % or more, more preferably 80 mass % or more, still more preferably 85 mass % or more, and particularly preferably 90 mass % or more. Note that the protein content is a value on a dry matter basis (without water).

While protein raw material (b) above is not particularly limited as long as the protein content is 70 mass % or more, it is preferably a plant-derived protein, more preferably a protein derived from soybean, wheat, corn, or beans such as pea, and particularly preferably soybean protein. The use of soybean protein facilitates a higher degree of texturization together with (a) above. Furthermore, it facilitates swelling of the resulting texturized protein by water absorption, and when the texturized-protein food ingredient of the present invention is rehydrated in water and added to a food product, it can impart moderate firmness and elasticity to the food product.

Defatted soybean, which is a raw material of soybean protein, consists of sugar, ash, fibers (soybean pulp) such as cell walls, and proteins. In the present invention, defatted soybean can be used as it is as protein raw material (b) but it is particularly preferable to use an isolated soybean protein which is obtained by isolating protein alone from defatted soybean.

In addition, the nitrogen solubility index (NSI) of protein raw material (b) is preferably 55% or more but 100% or less, more preferably 60% or more but 95% or less, still more preferably 65% or more but 93% or less, and particularly preferably 70% or more but 90% or less.

As long as the NSI is within the above range, protein raw material (b) can easily texturize with protein raw material (a), and the swelling of the texturized protein can be facilitated so that the texturized-protein food ingredient of the present invention can impart moderate firmness and elasticity to a food product when it is rehydrated in water and added to the food product.

Here, “NSI” refers to the ratio of water-soluble nitrogen to total nitrogen, and can be determined by the method described in “The JOCS Standard Methods for the Analysis of Fats, Oils and Related Materials” (1971 edition) established by the Japan Oil Chemists' Society.

The content of protein raw material (b) in the raw material mixture is preferably 10 mass % or more but 95 mass % or less, more preferably 15 mass % or more but 90 mass % or less, still more preferably 20 mass % or more but 80 mass % or less, yet still more preferably 25 mass % or more but 70 mass % or less, and particularly preferably 28 mass % or more but 50 mass % or less, based on the total amount of the raw material mixture.

Moreover, the content of protein raw material (b) may be, for example, 45 mass % or less, or 40 mass % or less, based on the total amount of the raw material mixture. According to the present invention, even if the content of protein raw material (a) is increased, its impact on the tastiness of a food product can be kept low, and the content of protein raw material (b) can be reduced.

Furthermore, the content of protein raw material (b) is preferably 10 mass % or more but 95 mass % or less, more preferably 15 mass % or more but 90 mass % or less, still more preferably 20 mass % or more but 80 mass % or less, yet still more preferably 25 mass % or more but 70 mass % or less, and particularly preferably 30 mass % or more but 50 mass % or less, based on the total amount of the protein raw materials contained in the raw material mixture.

Moreover, the content of protein raw material (b) may be, for example, 45 mass % or less, or 40 mass % or less, based on the total amount of the raw material mixture.

### (c) Other Components

In one embodiment of the present invention, the raw material mixture may contain a protein raw material different from (a) and (b) above to an extent that it does not impair the purpose of the present invention. For example, a protein raw material with a protein content of less than 70 mass % may be contained in a small amount (e.g., less than 10 mass % based on the total amount of the raw material mixture).

In a preferred aspect of the present invention, the total content of (a) and (b) among the protein raw materials contained in the raw material mixture is preferably 70 mass % or more, more preferably 80 mass % or more, still more preferably 90 mass % or more, particularly preferably 95 mass % or more, and may be 100 mass %, based on the total amount of the protein raw materials contained in the raw material mixture.

The raw material mixture may also contain other additives. In such cases, the resulting texturized protein will contain a small amount of additives. The additives are not particularly limited. For example, a processing aid such as calcium carbonate, calcium sulfate, calcium chloride, and magnesium sulfate can be used to stabilize bubbles made during production. One or more additives such as a seasoning, a flavoring, an oil/fat, dietary fiber, a colorant, a starch, and a polysaccharide thickener may also be used.

The content of the additives is, for example, 5 mass % or less, preferably 0.1 mass % or more but 5 mass % or less, more preferably 0.2 mass % or more but 3 mass % or less, still more preferably 0.3 mass % or more but 2 mass % or less, and particularly preferably 0.5 mass % or more but 1.5 mass % or less, based on the total amount of the raw material mixture.

Texturized proteins, which are made by texturizing raw material mixtures, can be classified into: granular proteins that have been formed into granules or flakes; fibrotic proteins that have been formed into fibers; and the like, depending on their shapes. According to the present invention, the shape of the texturized protein is not particularly limited, and it can be cut into an appropriate shape using a rotary cutter or the like. The shape of the texturized protein can be suitably selected according to the type, purpose, etc. of the food product to which the texturized-protein food ingredient of the present invention is to be added.

In the texturized-protein food ingredient of the present invention, the protein content in the raw material mixture is preferably 35 mass % or more, more preferably 40 mass % or more, still more preferably 45 mass % or more, yet still more preferably 50 mass % or more, and particularly preferably 55 mass % or more, based on the total amount of the raw material mixture. As long as the protein content in the texturized protein is within the above range, the swelling of the texturized protein can be facilitated so that the texturized-protein food ingredient of the present invention can impart firmness and elasticity when it is rehydrated in water. Moreover, the protein content in the texturized protein may be, for example, 100 mass %, 90 mass % or less, 80 mass % or less, or 70 mass % or less, based on the total amount of the raw material mixture. The protein content in the texturized protein can be determined by the combustion method described above.

The texturized protein used for the texturized-protein food ingredient of the present invention can be produced by kneading a raw material mixture containing protein raw materials (a) and (b), if necessary, other protein raw materials, and optional additives, in the presence of water under pressure/heat treatment conditions, texturing the resultant by extruding it under normal pressure, and then drying it. As described above, the resulting texturized protein is a dry product from which excess moisture has been removed.

The texturized protein obtained as described above can be used directly as a texturized-protein food ingredient. In this case, the content of the texturized protein is 100 mass % based on the total amount of the texturized-protein food ingredient.

Alternatively, in one embodiment, the texturized-protein food ingredient of the present invention may contain, in addition to the texturized protein, one or more additives such as a seasoning, a flavoring, an oil/fat, dietary fiber, a colorant, a starch, and a polysaccharide thickener.

In this case, the texturized-protein food ingredient of the present invention can be obtained by mixing the texturized protein and the additives. The types and amounts of the additives can be suitably selected according to the application and purpose of the texturized-protein food ingredient of the present invention.

However, even when additives are used, the content of the texturized protein in the texturized-protein food ingredient is preferably above a certain amount, which is preferably 70 mass % or more, more preferably 80 mass % or more, still more preferably 90 mass % or more, yet still more preferably 95 mass % or more, and particularly preferably 98 mass % or more, based on the total amount of the texturized-protein food ingredient.

Since the texturized-protein food ingredient of the present invention has excellent swellability, it can be used after it has been rehydrated by water absorption to impart a moderate texture to a food product. The water absorption rate of the texturized-protein food ingredient of the present invention is preferably 150 mass % or more but 500 mass % or less, more preferably 200 mass % or more but 450 mass % or less, and still more preferably 250 mass % or more but 425 mass % or less, based on the total amount of the texturized protein.

The texturized-protein food ingredient of the present invention may be used as it is. For example, if other ingredient of a food product contains water, the texturized-protein food ingredient of the present invention can be mixed directly with other ingredient so that it is rehydrated by absorbing the water, thereby imparting a texture to the food product.

For the method for producing a texturized-protein food ingredient of the present invention, see “2. Method for producing texturized-protein food ingredient”.

### 2. Method for Producing Texturized-Protein Food Ingredient

A method for producing a texturized-protein food ingredient of the present invention comprises:
Step (1) in which a raw material mixture containing:
(a) an algae-derived protein raw material; and
(b) a protein raw material that is different from (a) and that has a protein content of 70 mass % or more, is pressurized and heat-treated in the presence of water to texturize the protein raw materials contained in said raw material mixture; and
Step (2) in which the texturized product obtained in the above step is dried to obtain a texturized protein.

The raw material mixture containing protein raw materials (a) and (b) is as described in “1. Texturized-protein food ingredient” above.

### <Step (1)>

In Step (1), a raw material mixture containing protein raw materials (a) and (b) above is pressurized and heat-treated in the presence of water to texturize the protein raw materials contained in said raw material mixture.

The raw material mixture can be pressurized and heat-treated using an extruder or the like.

The extruder may be either a single-shaft or twin-shaft extruder. The extruder is not particularly limited as long as it is a commonly used extruder. For example, an extruder equipped with a twin screw, a cylinder (barrel), a die, a driver, and a temperature controller, and if necessary, a rotary cutter or a cutting head at the outlet, can be advantageously used.

When pressuring and heat-treating a raw material mixture using an extruder, the barrel temperature condition is preferably 30° C. or higher but 250° C. or lower, more preferably 30° C. or higher but 230° C. or lower, still more preferably 40° C. or higher but 200° C. or lower, and particularly preferably 50° C. or higher but 180° C. or lower.

In addition, the pressure condition is preferably 0.5 MPa or more but 100 MPa or less, more preferably 0.5 MPa or more but 80 MPa or less, still more preferably 0.5 MPa or more but 60 MPa or less, and particularly preferably 0.5 MPa or more but 40 MPa or less.

For example, when the raw material mixture is pressurized and heat-treated using an extruder, the raw material mixture containing protein raw materials (a) and (b), and, if necessary, other protein raw material, is kneaded under pressure/heat treatment conditions while adding water, and then extruded under normal pressure, thereby texturizing the protein raw materials contained in the raw material mixture.

More specifically, a raw material mixture containing protein raw materials (a) and (b), if necessary, other protein raw material, and optional additives, is fed into the extruder, and after adding water at an amount of 10 mass % or more but 70 mass % or less based on the total amount of the raw material mixture, the raw material mixture is pressurized and heat-treated under the conditions of, for example, a barrel temperature of 30° C. or higher but 250° C. or lower, an outlet temperature of 80° C. or higher but 180° C. or lower, a screw speed of 100 rpm or more but 1,000 rpm or less, and a heat treatment time of 7 seconds or more but 50 seconds or less, thereby texturizing the protein raw materials.

More specifically, the temperature conditions in this case are more preferably as follows: a barrel temperature of 30° C. or higher but 230° C. or lower, an outlet temperature of 100° C. or higher but 160° C. or lower, a barrel temperature of 50° C. or higher but 180° C. or lower, and an outlet temperature of 110° C. or higher but 145° C. or lower.

As to the conditions for adding water, it is more preferable to adjust the proportion of water added to 10 mass % or more but 70 mass % or less, still more preferable to 15 mass % or more but 50 mass % or less, and particularly preferable to 20 mass % or more but 40 mass % or less, based on the total amount of the raw material mixture.

The screw speed is more preferably 150 rpm or more but 900 rpm or less and still more preferably 200 rpm or more but 850 rpm or less.

Moreover, the heating/pressurizing time is more preferably 7 seconds or more but 50 seconds or less and still more preferably 10 seconds or more but 45 seconds or less.

The texturized product obtained by pressurizing and heat-treating the raw material mixture as described above is in a swollen state by water absorption.

### <Step (2)>

In Step (2), the texturized product obtained in Step (1) is dried to obtain a texturized protein.

If necessary, the texturized product obtained in Step (1) can be cut or pulverized into a desired shape using a rotary cutter or the like before being dried in a dryer to obtain a texturized protein. If necessary, the thus obtained texturized protein may be further cut or pulverized into a desired shape.

The dryer is not particularly limited as long as it is commonly used in the process of manufacturing a food product.

From the viewpoints of drying efficiency and flavor, the drying temperature is preferably 30° C. or higher but 150° C. or lower, more preferably 40° C. or higher but 140° C. or lower, and still more preferably 50° C. or higher but 130° C. or lower.

The drying time is not particularly limited and can be suitably selected according to the drying method and else. Drying is performed until the moisture content of the texturized protein is within the specified range.

The moisture content in the texturized protein after drying is preferably 10 mass % or less, more preferably 9 mass % or less, and still more preferably 8 mass % or less based on the total amount of the texturized protein.

The texturized protein obtained as described above has excellent swellability, and can have moderate firmness and elasticity when rehydrated by water absorption. The water absorption rate of the texturized protein is as described in “1. Texturized-protein food ingredient” above.

After obtaining the texturized protein through the above steps, it can be mixed with additives as necessary to obtain a texturized-protein food ingredient of interest. The types and amounts of additives are as described in “1. Texturized-protein food ingredient” above.

### 3. Food Product

The texturized-protein food ingredient of the present invention can be added to a food product to impart the nutritional value of the algae to the food product while minimizing the impact of the color, smell, and texture peculiar to the algae on the tastiness of the food product. For example, the texturized-protein food ingredient of the present invention can be added to or blended with a food product by using it with ingredients of the food product.

The texturized-protein food ingredient of the present invention can be used as it is, but it is preferable to use it after rehydrating it in water, because it is easy to impart a moderate texture to the food product. When the texturized-protein food ingredient of the present invention is used as it is, it can be rehydrated by absorbing moisture contained in other raw ingredient, thereby imparting a moderate texture to the food product.

The water absorption rate of the texturized-protein food ingredient is not particularly limited and can be adjusted according to the type and purpose of the food product, desired texture, and the like, but it is preferably 150 mass % or more but 500 mass % or less, more preferably 200 mass % or more but 450 mass % or less, and still more preferably 250 mass % or more but 425 mass % or less, based on the total amount of the texturized protein.

The food product containing the texturized-protein food ingredient of the present invention is not particularly limited as long as the texturized-protein food ingredient is applicable thereto, and examples thereof include processed meat products, processed meat-like products, processed fishery products, confectionery such as snack foods, and nutritional supplements such as protein bars.

Examples of the processed meat products include patties, hamburger steak, Gyoza (one type of Chinese dumpling), sausages, cutlets, minced meat cutlet, Shumai (one type of Chinese dumpling), meatballs, Niku-dango (Japanese meatballs), Chinese steamed buns, Tsukune (Japanese chicken meatballs), and nuggets. The texturized-protein food ingredient of the present invention can be suitably used as a substitute ingredient for meat in these food products. The meat included in the ingredients of a processed meat product may be partially replaced with the texturized-protein food ingredient of the present invention to obtain a processed meat product (such that, for example, the content of the texturized-protein food ingredient of the present invention rehydrated in water is 5 mass % or more but 90 mass % or less, preferably 20 mass % or more but 80 mass % or less, and more preferably 30 mass % or more but 70 mass % or less, based on the total amount of the meat).

Processed meat-like food products are food products that contain no meat or reduced amounts of meat.

Examples of the processed meat-like products include patties, hamburger steak, Gyoza (one type of Chinese dumpling), sausages, cutlets, minced meat cutlet, Shumai (one type of Chinese dumpling), meatballs, Niku-dango (Japanese meatballs), Chinese steamed buns, Tsukune (Japanese chicken meatballs), and nuggets. The texturized-protein food ingredient of the present invention can be suitably used as a substitute ingredient for meat or vegetable protein in these food products. The meat or vegetable protein included in the ingredients of a processed meat-like product may be partially or completely replaced with the texturized-protein food ingredient of the present invention to obtain a processed meat-like product (such that, for example, the content of the texturized-protein food ingredient of the present invention rehydrated in water is 5 mass % or more but 100 mass % or less, preferably 10 mass % or more but 70 mass % or less, and more preferably 20 mass % or more but 50 mass % or less, based on the total amount of the meat or vegetable protein).

Examples of the processed fishery products include Kamaboko (one type of fish cake), Chikuwa (one type of fish cake), Hanpen (one type of fish cake), fish balls, and fish sausages. The texturized-protein food ingredient of the present invention can be suitably used as a substitute ingredient for fish meat in these food products. The fish meat included in the ingredients of a processed fishery product may be partially or completely replaced with the texturized-protein food ingredient of the present invention to obtain a processed fishery product (such that, for example, the content of the texturized-protein food ingredient of the present invention rehydrated in water is 5 mass % or more but 100 mass % or less, preferably 10 mass % or more but 70 mass % or less, and more preferably 20 mass % or more but 50 mass % or less, based on the total amount of the fish meat).

The content of the texturized-protein food ingredient of the present invention is not particularly limited and can be suitably selected according to the type, purpose, etc. of the food product. When the food product is, for example, a processed meat product or a processed meat-like product, the content of the texturized-protein food ingredient rehydrated in water is preferably 5 mass % or more but 90 mass % or less, more preferably 10 mass % or more but 70% or less, and still more preferably 15 mass % or more but 50 mass % or less, based on the total amount of the processed meat product or processed meat-like product. Alternatively, when the food product is, for example, a processed fishery product, the content of the texturized-protein food ingredient rehydrated in water is 5 mass % or more but 90 mass % or less, preferably 10 mass % or more but 70% or less, and more preferably 15 mass % or more but 50 mass % or less, based on the total amount of the processed fishery product.

### 4. Method for Improving Texture of Food Product

The present invention also relates to a method for improving the texture of a food product, comprising blending the above-described texturized-protein food ingredient with the food product.

As mentioned above, the texturized-protein food ingredient of the present invention can have moderate firmness and elasticity when rehydrated in water. The firmness and elasticity of the texturized-protein food ingredient of the present invention can be adjusted by controlling the degree of swelling of the texturized protein contained in the texturized-protein food ingredient of the present invention. The degree of swelling and water absorption rate are correlated, and the more the texturized protein swells, the more easily it absorbs water, and the higher the water absorption rate. According to the present invention, a texturized protein with excellent swellability can be obtained by combining protein raw materials (a) and (b), thereby providing a texturized-protein food ingredient with a high water absorption rate. The degree of swelling of the texturized protein can be further controlled by suitably adjusting the pressure/heat treatment conditions including the proportion of water added, the screw speed, and the barrel temperature.

Such a texturized-protein food ingredient of the present invention can impart moderate firmness and elasticity to a food product and improve the texture thereof by being added to the food product after being rehydrated in water, or by being blended directly with other food ingredients and then being rehydrated by water absorption. At the same time, it also has the advantage of imparting the nutritional value of the algae to the food product.

The amount of the texturized-protein food ingredient of the present invention after being rehydrated in water depends on the type and purpose of the food product. Although it is difficult to say, usually, the texturized-protein food ingredient will have a high effect on improving the texture when its amount is preferably 5 mass % or more but 90 mass % or less, more preferably 10 mass % or more but 70 mass % or less, and still more preferably 15 mass % or more but 50 mass % or less, based on the total amount of the food product.

### EXAMPLES

Hereinafter, the present invention will be described in more detail by way of examples, although the present invention is not limited in any way to these examples. Unless otherwise mentioned, “%” is on a mass basis.

### [1] Preparation of Texturized-Protein Food Ingredient

Texturized-protein food ingredients were prepared using the compositions listed in Table 1.

### Examples 1-1, 1-2, and 1-3

Euglena (50 mass % based on the total amount of the protein raw materials), isolated soybean protein (50 mass % based on the total amount of the protein raw materials), and calcium carbonate (1 mass % based on the total amount of the protein raw materials) were mixed until they were thoroughly homogeneous to obtain a powdery mixture. The resulting powdery mixture was pressurized and heat-treated using a twin-screw extruder (“KEI-45” manufactured by Kowa Kogyo Inc.) while adding water at the amount ratio listed in Table 1.

Subsequently, the mixture was extruded under normal pressure through a die attached to the discharge port, cut into granules of approximately 1-6 mm with a cutter, and placed and dried in a dryer (“ECO-12” manufactured by Washio Churi Industry Co., Ltd., set temperature 110° C.) for about 40 minutes until the moisture content was 10 mass % or less, thereby obtaining a texturized-protein food ingredient of the present invention.

### <Pressure/Heat Treatment Conditions>

Rate of supplying raw materials: 340 g/min
Addition of water (relative to raw material mixture): 32.9 to 37.1 mass %
Barrel temperature: 50° C., 100° C., 180° C., and 130° C. from the inlet toward the outlet for the raw materials
Outlet temperature: Around 120° C.
Screw speed: 250 rpm

### Example 1-4

A texturized-protein food ingredient was prepared in the same manner as in Example 1-1, except that Defatted euglena 1 was used instead of euglena as a protein raw material.

### Example 1-5

A texturized-protein food ingredient was prepared in the same manner as in Example 1-1, except that Defatted euglena 2 (70 mass % based on the total amount of protein raw materials) and isolated soybean protein (30 mass % based on the total amount of protein raw materials) were used as protein raw materials.

### Example 1-6

A texturized-protein food ingredient was prepared in the same manner as in Example 1-1, except that Defatted euglena 2 was used instead of euglena as a protein raw material.

### Comparative Examples 1-1, 1-2, and 1-3

Texturized-protein food ingredients were prepared in the same manner as in the above-described examples, except that euglena alone, defatted euglena alone, or chlorella alone was used as a protein raw material, respectively.

### [Adjustment of Particle Size of Texturized-Protein Food Ingredient]

The obtained texturized-protein food ingredient was sieved and adjusted so that 15 mass % of the ingredient had a particle size of 1 mm or more but less than 3.35 mm and 85 mass % had a particle size of 3.35 mm or more but 5.6 mm or less.

### [Sensory Evaluation]

The obtained texturized-protein food ingredients were evaluated. To the texturized-protein food ingredient with adjusted particle sizes, 2.5 times (by mass) the amount of water was added, the resultant was left to stand for 10 minutes so that the food ingredient fully absorbed the water and then evaluated. The evaluators were a panel of three trained experts. The evaluation items and criteria were as follows. The color was evaluated by one panelist, and the smell and texture were evaluated by three panelists. For manufacturability, swellability, and water absorption rate, “O” indicates that the ingredient was acceptable. For color, smell, and texture, “O” and “A” indicate that the ingredient was acceptable. The results are shown in Table 1.

### [Method for Measuring Water Absorption Rate]

1. Five grams (5 g) of texturized-protein food ingredient (A) with adjusted particle sizes was weighed in a 50 ml tube.
2. To the texturized-protein food ingredient with adjusted particle sizes in 1, 40 ml (8 times the amount) of water was added, and the resultant was mixed by inversion and left to stand for 1 hour.
3. The mixture in 2 was inverted on a 500 μm sieve, the water was filtered out, and the pellet mass on the sieve (B) was measured to calculate water absorption rate (%) as (B−A/A)×100.
(1) Manufacturability
∘: Stably discharged in an unbreakable manner at the outlet of the extruder
x: Unstable due to the tendency of the discharge to run out at the outlet of the extruder and the degree of swelling being variable.
(2) Swellability
∘: Discharged in a swollen state at the outlet of the extruder
x: Discharged in a compressed state without swelling at the outlet of the extruder
(3) Water absorption rate
∘: Water absorption rate of 250% or more
x: Water absorption rate less than 250%
(4) Color
∘: Whitish green, brown
Δ: Dark green to slightly reddish green
x: Dark green, green
(5) Smell
∘: Smell of the sea was weak
Δ: Smell of the sea was slightly weak
x: Smell of the sea was strong
(6) Texture
∘: Meat-like firmness and elasticity were felt
Δ: Firm but not elastic
x: Fragile and crumbling, no firmness or elasticity at all

TABLE 1

| | | Example 1-1 | Example 1-2 | Example 1-3 | Example 1-4 | Example 1-5 |
|---|---|---|---|---|---|---|
| Raw material | Euglena | 50.0% | 50.0% | 50.0% | | |
| mixture | Defatted | | | | 50.0% | 70.0% |
| | euglena 1 | | | | | |
| | Defatted | | | | | |
| | euglena 2 | | | | | |
| | Chlorella | | | | | |
| | Isolated | 50.0% | 50.0% | 50.0% | 50.0% | 30.0% |
| | soybean | | | | | |
| | protein | | | | | |
| | Ca carbonate | 1.0% | 1.0% | 1.0% | 1.0% | 1.0% |
| | (per protein | | | | | |
| | raw material) | | | | | |
| Protein content | | 59.4% | 59.4% | 59.4% | 60.5% | 49.0% |
| Addition of water | | 35.3-37.1% | 32.9-34.1% | 23.5% | 36.8% | 36.8% |
| (per raw material | | | | | | |
| mixture) | | | | | | |
| Manufacturability | ◯X | ◯ | ◯ | ◯ | ◯ | ◯ |
| Swellability | ◯X | ◯ | ◯ | ◯ | ◯ | ◯ |
| Water absorption rate | ◯X | ◯ | ◯ | ◯ | ◯ | ◯ |
| | Water | 334% | 282% | 415.2% | 345.1% | 422.2% |
| | absorption | | | | | |
| | rate | | | | | |
| Texture | ◯ΔX | ◯ | ◯ | ◯ | ◯ | ◯ |
| | Comments | Firm and elastic | | | Firm and elastic but slightly | |
| | | | | | soft | |
| Smell | ◯ΔX | Δ | Δ | Δ | ◯ | ◯ |

| | | |
|---|---|---|
| Comments | Smell of the sea from euglena and smell of | Smell of the sea from euglena |
| | soybean were slightly weak | and smell of soybean were |
| | | weak |

| Color | Slightly dark | Slightly reddish dark green | | Whitish green | |
|---|---|---|---|---|---|
| | green | | | | |
| | Δ | Δ | Δ | ◯ | O |

| | | | Comparative | Comparative | Comparative |
|---|---|---|---|---|---|
| | | Example 1-6 | example 1-1 | example 1-2 | example 1-3 |
| Raw material | Euglena | | 100.0% | | |
| mixture | Defatted | | | 100.0% | |
| | euglena 1 | | | | |
| | Defatted | 50.0% | | | |
| | euglena 2 | | | | |
| | Chlorella | | | | 100.0% |
| | Isolated | 50.0% | | | |
| | soybean | | | | |
| | protein | | | | |
| | Ca carbonate | 1.0% | 1.0% | 1.0% | 1.0% |
| | (per protein | | | | |
| | raw material) | | | | |
| Protein content | | 60.5% | 29.7% | 31.9% | 54.5% |
| Addition of water | | 36.8% | 32.9-37.1% | 32.9-37.1% | 36.8% |
| (per raw material | | | | | |
| mixture) | | | | | |
| Manufacturability | ◯X | ◯ | X | X | X |
| Swellability | ◯X | ◯ | X | X | X |
| Water absorption rate | ◯X | ◯ | X | X | X |
| | Water | 308.2% | Less than | Less than | 182.8% |
| | absorption | | 250% | 250% | |
| | rate | | | | |
| Texture | ◯ΔX | ◯ | X | Δ | X |
| | Comments | Firm and | Quite fragile | Firm | Quite fragile |
| | | elastic | and soggy | | and soggy |
| Smell | ◯ΔX | ◯ | X | X | X |
| | Comments | Smell of the sea from | Quite strong | Euglena | Peculiar smell |
| | | euglena and smell of | euglena smell | smell was | (like green juice) |
| | | soybean were | | present | |
| | | the weakest | | | |

| | | | | |
|---|---|---|---|---|
| Color | Brown | Green | Reddish light | Quite dark |
| | | | green | green |
| | ◯ | X | Δ | X |

Each of the ingredients in Table 1 was as follows.

TABLE 2

| | Protein | |
|---|---|---|
| | content in each | |
| | protein raw | |
| | material | Product name, Manufacturer |
| Euglena | 30.0% | Euglena gracilis (autotrophic type), Euglena Co., Ltd. |
| Defatted euglena 1 | 32.2% | Produced according to Method for preparing Defatted |
| | | euglena 1 |
| Defatted euglena 2 | 32.2% | Produced according to Method for preparing Defatted |
| | | euglena 2 |
| Chlorella | 55.0% | Yaeyama Chlorella, Yaeyama Shokusan Co., Ltd. |
| Isolated soybean | 90.0% | SUPRO PM, DuPont (which meets the NSI range of 55% |
| protein | | or more but 100% or less) |
| Calcium carbonate | 0.0% | COLLOCALSO-EX, Shiraishi Calcium Kaisha, Ltd. |

### <Method for Preparing Defatted Euglena 1>

1. Euglena powder (using the euglena listed in Table 2) was weighed into a stainless steel mug to which twice the amount of hexane was added, allowing the powder to soak for 1 hour. In doing so, the mixture was stirred with a spatula approximately every 15 minutes.
2. The supernatant of 1 was filtered through No. 2 filter paper, and a new amount of hexane equal to that decanted was added to the residue.
3. The residue was spread on a stainless steel cooking tray and air-dried in a draft chamber overnight.
4. The air-dried residue was vacuum-dried at 60° C. for 2 hours to obtain Defatted euglena 1.

### <Method for Preparing Defatted Euglena 2>

1. Euglena powder (Euglena gracilis (heterotrophic type), Euglena Co., Ltd.) was weighed into a stainless steel mug to which twice the amount of ethanol was added and heated at 70° C. for 1 hour. After heating, the mixture was left to stand still until the temperature dropped to 50° C.
2. The supernatant of 1 was filtered through No. 2 filter paper.
3. The residue was spread on a stainless steel cooking tray and air-dried in a draft chamber overnight.
4. The air-dried residue was vacuum-dried at 60° C. for 2 hours to obtain Defatted euglena 2.

As shown in Table 1, when euglena and isolated soy protein were used as protein raw materials, they texturized, swelled sufficiently, and developed less color and smell and had a firmer and more elastic texture than when euglena alone was used (Examples 1-1 to 1-3).

In addition, when Defatted euglena 1 and isolated soy protein were used as protein raw materials, they also texturized, swelled, and developed color and smell and had a firmer (although slightly soft) and more elastic texture than when euglena alone was used (Examples 1-4 and 1-5). Similarly, when Defatted euglena 2 and isolated soy protein were used, they texturized, swelled, and developed less color and smell and had a firmer and more elastic texture than when euglena alone was used (Example 1-6).

The resulting texturized proteins can be favorably used as texturized-protein food ingredients.

On the other hand, when euglena alone was used as the protein raw material, it did not texturize, the color and smell peculiar to euglena remained strongly, it was quite fragile, did not gain elasticity, and the texture was poor (Comparative example 1-1). When defatted euglena alone was used, it somewhat texturized, but swelling was insufficient, it did not absorb water sufficiently, the color and smell peculiar to euglena remained, and an elastic texture could not be obtained (Comparative example 1-2). The same also happened when chlorella alone was used as the protein raw material, and it did not texturize, the color and smell peculiar to chlorella remained strongly, it was quite fragile, did not gain elasticity, and the texture was poor (Comparative example 1-3).

### [2] Food Product Containing Texturized-Protein Food Ingredient (Hamburger Steak)

Hamburger steaks were prepared according to the following procedure using the ingredients listed in Table 3.
1. Granular soybean protein materials A and C, and texturized products were each added with twice the amount of water to be rehydrated. The euglena powder in Comparative example 2-1 was not added with water at this point, but was added with water in 2.
2. Granular soybean protein material A rehydrated in water down to the flavor enhancer (granular meat part) in the list were mixed well.
3. Gluten meat and granulated soybean protein ingredient C rehydrated in water were put in a food processor and mixed well.
4. To the mixture obtained in 3, egg white powder down to flavoring oil (binder part) in the list were added and mixed well.
5. The mixtures obtained in 2 and 4 were mixed well.
6. The starch ingredient and columnar oil/fat were mixed with the mixture obtained in 5, thereby preparing the hamburger patty.
7. Hundred grams of the hamburger patty obtained in 6 was shaped to have a diameter of 10 cm.
8. The patty was cooked in a frying pan over medium heat for about 2 minutes each side, thereby preparing a hamburger steak.

TABLE 3

| | Comparative | | | | | | | | | |
|---|---|---|---|---|---|---|---|---|---|---|
| | example 2-1 | | Example 2-1 | | Example 2-2 | | Example 2-3 | | Example 2-4 | |
| Ingredients | g | % | g | % | g | % | g | % | g | % |
| Granulated soybean protein | 5 | 5.0% | | 0.0% | 2.87 | 2.9% | | 0.0% | | 0.0% |
| ingredient A | | | | | | | | | | |
| Water addition | 10 | 10.0% | | 0.0% | 5.73 | 5.7% | | 0.0% | | 0.0% |
| Euglena powder | 5 | 5.0% | | 0.0% | | 0.0% | | 0.0% | | 0.0% |
| Texturized-protein food ingredient | | 0.0% | 10 | 10.0% | | 0.0% | | 0.0% | | 0.0% |
| (Example 1-6) | | | | | | | | | | |
| Texturized-protein food ingredient | | 0.0% | | 0.0% | 7.13 | 7.1% | | 0.0% | | 0.0% |
| (Example 1-5) | | | | | | | | | | |
| Texturized-protein food ingredient | | 0.0% | | 0.0% | | 0.0% | 10 | 10.0% | | 0.0% |
| (Example 1-1) | | | | | | | | | | |
| Texturized-protein food ingredient | | 0.0% | | 0.0% | | 0.0% | | 0.0% | 10 | 10.0% |
| (Example 1-4) | | | | | | | | | | |
| Water addition | 10 | 10.0% | 20 | 20.0% | 14.27 | 14.3% | 20 | 20.0% | 20 | 20.0% |
| Sauteed onions | 11 | 11.0% | 11 | 11.0% | 11 | 11.0% | 11 | 11.0% | 11 | 11.0% |
| Black pepper | 0.4 | 0.4% | 0.4 | 0.4% | 0.4 | 0.4% | 0.4 | 0.4% | 0.4 | 0.4% |
| Salt | 0.2 | 0.2% | 0.2 | 0.2% | 0.2 | 0.2% | 0.2 | 0.2% | 0.2 | 0.2% |
| Egg white powder | 3 | 3.0% | 3 | 3.0% | 3 | 3.0% | 3 | 3.0% | 3 | 3.0% |
| Granulated sugar | 0.4 | 0.4% | 0.4 | 0.4% | 0.4 | 0.4% | 0.4 | 0.4% | 0.4 | 0.4% |
| Beet root powder | 0.1 | 0.1% | 0.1 | 0.1% | 0.1 | 0.1% | 0.1 | 0.1% | 0.1 | 0.1% |
| Flavoring oil | 1 | 1.0% | 1 | 1.0% | 1 | 1.0% | 1 | 1.0% | 1 | 1.0% |
| Shortening A | 10 | 10.0% | 10 | 10.0% | 10 | 10.0% | 10 | 10.0% | 10 | 10.0% |
| Flavor enhancer | 0.4 | 0.4% | 0.4 | 0.4% | 0.4 | 0.4% | 0.4 | 0.4% | 0.4 | 0.4% |
| Gluten meat | 15 | 15.0% | 15 | 15.0% | 15 | 15.0% | 15 | 15.0% | 15 | 15.0% |
| Granulated soybean protein | 1.67 | 1.7% | 1.67 | 1.7% | 1.67 | 1.7% | 1.67 | 1.7% | 1.67 | 1.7% |
| ingredient C | | | | | | | | | | |
| Water addition | 3.33 | 3.3% | 3.33 | 3.3% | 3.33 | 3.3% | 3.33 | 3.3% | 3.33 | 3.3% |
| Egg white powder | 3 | 3.0% | 3 | 3.0% | 3 | 3.0% | 3 | 3.0% | 3 | 3.0% |
| Salt | 0.5 | 0.5% | 0.5 | 0.5% | 0.5 | 0.5% | 0.5 | 0.5% | 0.5 | 0.5% |
| Shortening B | 6 | 6.0% | 6 | 6.0% | 6 | 6.0% | 6 | 6.0% | 6 | 6.0% |
| Canola oil | 5 | 5.0% | 5 | 5.0% | 5 | 5.0% | 5 | 5.0% | 5 | 5.0% |
| Flavoring oil | 1 | 1.0% | 1 | 1.0% | 1 | 1.0% | 1 | 1.0% | 1 | 1.0% |
| Starch ingredient | 1 | 1.0% | 1 | 1.0% | 1 | 1.0% | 1 | 1.0% | 1 | 1.0% |
| Columnar oil/fat | 7 | 7.0% | 7 | 7.0% | 7 | 7.0% | 7 | 7.0% | 7 | 7.0% |
| Total | 100 | 100.0% | 100 | 100.0% | 100 | 100.0% | 100 | 100.0% | 100 | 100.0% |

Each of the ingredients in Table 3 was as follows.

TABLE 4

| Ingredients | Product name, Manufacturer |
|---|---|
| Granulated soybean protein ingredient A | Fujinic Ace 500, Fuji Oil Co., Ltd. |
| Granulated soybean protein ingredient B | Vegitex SHF, Fuji Oil Co., Ltd. |
| Euglena powder | Euglena gracilis (autotrophic type), Euglena Co., Ltd. |
| Sauteed onions | Onion sauteed in edible rapeseed oil |
| Egg white powder | Dried egg white, Kewpie Corporation |
| Beet root powder | Beet root fine powder, Kukoku Vegeful Co. |
| Flavoring oil | J-OIL PRO Meat Cooked Oil, J-OIL MILLS |
| Shortening A | S-Special, J-OIL MILLS |
| Flavor enhancer | Aji-no-moto, Ajinomoto Co., Inc. |
| Gluten meat | Gluten Meat, Saniku Foods Co., Ltd. |
| Granulated soybean protein ingredient C | Apex 950, Fuji Oil Co., Ltd. |
| Egg white powder | Dried egg white, Kewpie Corporation |
| Shortening B | Euromelt 20B, J-OIL MILLS |
| Canola oil | Edible rapeseed oil, J-OIL MILLS |
| Starch ingredient | Neotrust W-120, J-OIL MILLS |
| Columnar oil/fat | Oil/fat composition 13 described in WO2020/004058 |

The resulting hamburger steaks were evaluated. The evaluators were a panel of three trained experts. The evaluation items and their scores were as follows. The score was the sum of the scores divided by the number of panel members (i.e., the average value). The color was evaluated by one panelist, and the smell and texture were evaluated by three panelists. The results are shown in Table 5.

### (1) Color

The color of the cross section of the hamburger steak was checked.

### (2) Texture (Elasticity, Firmness)

### (Elasticity)

5: Very elastic
4: Elastic
3: Slightly elastic
2: Weak elasticity
1: No elasticity

### (Firmness)

5: Very meat-like firmness
4: Meat-like firmness
3: Slightly meat-like firmness
2: Slightly soft
1: Very soft

### (3) Smell (Euglena Smell, Smell of the Sea)

5: No smell
4: Very weak smell
3: Slight smell
2: Smelled
1: Strong smell

TABLE 5

| | | Comparative | Example | Example | Example | Example |
|---|---|---|---|---|---|---|
| | | example 2-1 | 2-1 | 2-2 | 2-3 | 2-4 |
| Color | | Green | Light brown | Marginally | Slightly dim | Brown |
| | | | | dim green | green | |
| Texture | Elasticity | 2.0 | 3.7 | 3.3 | 3.3 | 3.3 |
| | Firmness | 2.3 | 4.3 | 3.3 | 3.0 | 3.3 |

| | | | | | |
|---|---|---|---|---|---|
| Smell | 1.0 | 4.0 | 3.3 | 1.7 | 3.3 |

As shown in Table 5, the hamburger steaks prepared using the texturized-protein food ingredient of the present invention had less color and smell peculiar to euglena than Comparative example 2-1 which was prepared using euglena powder, and they had moderate elasticity and firmness with a meat-like texture.

These results indicate that the texturized-protein food ingredient of the present invention is suitable as a food ingredient. It was also shown that the texture can be controlled by appropriately selecting the composition of the texturized-protein food ingredient of the present invention. The color, smell, and texture were particularly excellent when defatted euglena was used as the algae-derived protein raw material.

1. A texturized-protein food ingredient, comprising a texturized protein obtained by texturizing a raw material mixture containing:
(a) an algae-derived protein raw material; and
(b) a protein raw material that is different from (a) and that has a protein content of 70 mass % or more.

2. The texturized-protein food ingredient according to claim 1, wherein the algae is one or two species selected from the group consisting of euglena and defatted euglena.

3. The texturized-protein food ingredient according to claim 1, wherein the protein content in the raw material mixture is 35 mass % or more based on the total amount of said raw material mixture.

4. The texturized-protein food ingredient according to claim 1, wherein (b) above comprises a soybean protein.

5. The texturized-protein food ingredient according to claim 4, wherein the soybean protein comprises an isolated soybean protein.

6. The texturized-protein food ingredient according to claim 1, wherein the nitrogen solubility index (NSI) of (b) above is 55% or more but 100% or less.

7. The texturized-protein food ingredient according to claim 1, wherein the content of (a) above in the raw material mixture is 5 mass % or more but 90% or less based on the total amount of said raw material mixture.

8. A food product comprising the texturized-protein food ingredient according to claim 1.

9. The food product according to claim 8, wherein the food product is selected from the group consisting of a processed meat food product, a processed meat-like food product, and a processed fishery product.

10. A method for producing a texturized-protein food ingredient, comprising:
Step (1) in which a raw material mixture containing:
(a) an algae-derived protein raw material; and
(b) a protein raw material that is different from (a) and that has a protein content of 70 mass % or more,
is pressurized and heat-treated in the presence of water to texturize the protein raw materials contained in said raw material mixture; and
Step (2) in which the texturized product obtained in Step (1) above is dried to obtain a texturized protein.

11. The method for producing a texturized-protein food ingredient according to claim 10, wherein the algae is one or two species selected from the group consisting of euglena and defatted euglena.

12. The method for producing a texturized-protein food ingredient according to claim 10, wherein the pressurizing and heat treatment include pressurizing and heat treatment with an extruder.

13. A method for improving the texture of a food product, comprising blending the texturized-protein food ingredient according to claim 1 with the food product.
